(19) United States
(12) Patent Application Publication
(10) Pub. No.: US 2015/0127534 A1
(43) Pub. Date: May 7, 2015

(54) ELECTRONIC REFUND REDEMPTION

(71) Applicant: Bank of America Corporation, Charlotte, NC (US)

(72) Inventor: Madhu Madhav Bhambhani, London (GB)

(73) Assignee: Bank of America Corporation, Charlotte, NC (US)

(21) Appl. No.: 14/070,742

(22) Filed: Nov. 4, 2013

(51) Int. Cl. G06Q 20/40

(52) U.S. Cl. CPC G06Q 20/40
USPC 705/44

(57) ABSTRACT

A system for electronic refund redemption includes an interface operable to receive an electronic communication identifying a product purchased by a user from a vendor, an amount of value added tax (“VAT”) included for the purchased product, and VAT refund criteria associated with the VAT jurisdiction in which the products were purchased, wherein the VAT refund criteria identifies products subject to a VAT refund in the VAT jurisdiction, and a processor, communicatively coupled to the interface, operable to determine, based on the VAT refund criteria, that the purchased product qualifies for a VAT refund and a VAT refund amount for the purchased product.

### TECHNICAL FIELD

This disclosure relates generally to product refund redemption, and specifically to executing electronic product refund redemption.

### BACKGROUND

Products (e.g., goods and services) are often associated with refunds for all or a portion of the price paid for the product. Refunds may be offered by manufacturers, retailers, governments (e.g., tax refunds), or any other suitable entity. In certain circumstances, refunds are subject to qualification criteria and/or redemption criteria, which can make it difficult for customers to determine whether particular products qualify for refunds, and what redemption criteria the customer must comply with to receive the refund. Customers may purchase a large number of products associated with small refunds, but may not redeem the refund because the effort to determine whether each product qualifies for the refund, to determine the applicable redemption criteria for each qualifying product, and to follow through with satisfying the redemption criteria for each qualifying product can exceed the value of the refund for the customer.

For a particular type of product refund, a value added tax (“VAT”) refund available to travelers in certain jurisdictions, customers are often required to carry their passport while shopping to qualify for VAT refunds. A passport is a valuable document that is subject to theft, and many customers prefer to leave their passport in a secure location while traveling rather than carry it. Additionally, the redemption criteria for obtaining VAT refunds often involves manually entering customer information into an refund form, which can be time consuming and tedious. Customers must keep the physical redemption forms until they are able to redeem the VAT refund, for example, when the customer departs the jurisdiction (e.g., country) where the VAT refund eligible product was purchased. When customers have made a number of VAT refund eligible purchases, it can be cumbersome to keep track of all the VAT refund forms, especially while traveling.

### SUMMARY OF EXAMPLE EMBODIMENTS

According to embodiments of the present disclosure, disadvantages and problems associated with providing electronic refund redemption may be reduced or eliminated.

In an embodiment, a system for electronic refund redemption includes an interface operable to receive an electronic communication identifying a product purchased by a user from a vendor, an amount of value added tax included for the purchased product, and VAT refund criteria associated with the VAT jurisdiction in which the product was purchased, wherein the VAT refund criteria identifies products subject to a VAT refund in the VAT jurisdiction, and a processor, communicatively coupled to the interface, operable to determine, based on the VAT refund criteria, that the purchased product qualifies for a VAT refund and a VAT refund amount for the purchased product.

Certain embodiments of the present disclosure may provide one or more technical advantages having specific technical effects. In certain embodiments, a system for electronic refund redemption identifies products that qualify for refunds, thereby conserving the bandwidth, computational resources, and memory consumed by customers searching for information to determine whether products qualify for a refund.

In an embodiment, a system for electronic refund redemption identifies refund redemption criteria for a particular product refund, thereby conserving the bandwidth, computational resources, and memory consumed by customers searching for information to determine refund redemption criteria for particular products.

In particular embodiments, a system for electronic refund redemption includes an electronic passport, thereby preventing theft or loss of customer passports and conserving the bandwidth, computational resources, and memory consumed by obtaining replacement passports.

In certain embodiments, a system for electronic refund redemption facilitates electronic transfer of customer data to product refund forms, thereby conserving the bandwidth, computational resources, and memory consumed by manually entering customer information into a product refund form.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a block diagram of an example embodiment of a system for electronic refund redemption;

FIG. 2 illustrates a table of database fields that may be used in an example embodiment of electronic refund redemption; and

FIG. 3 illustrates an example embodiment of a method for electronic refund redemption.

### DETAILED DESCRIPTION

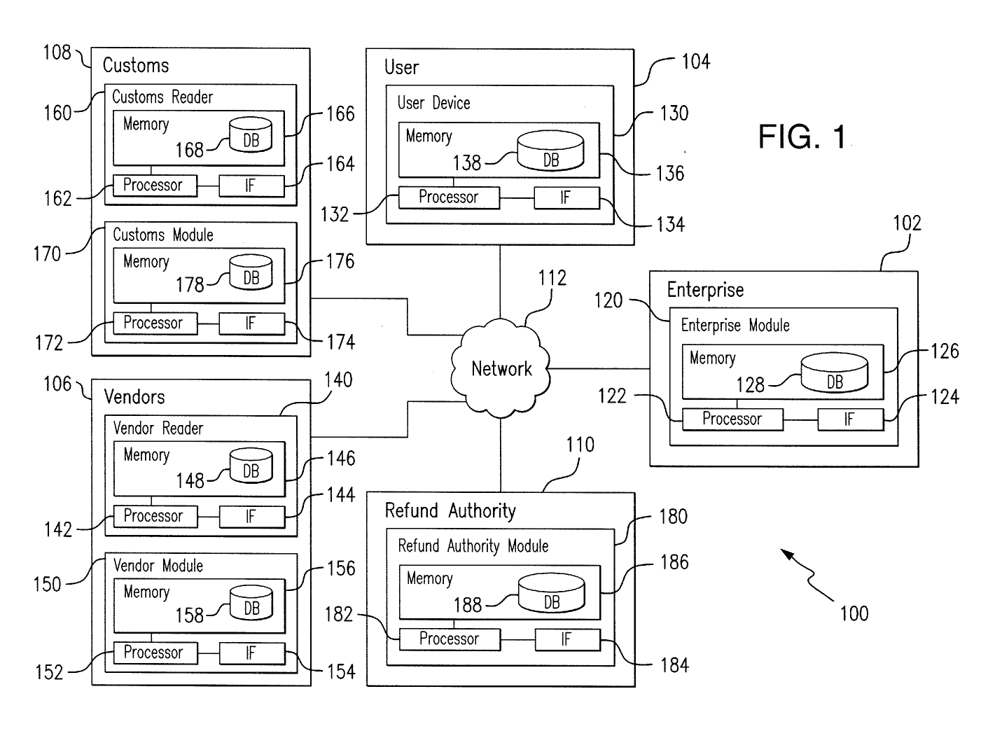

Embodiments of the present disclosure and its advantages are best understood by referring to FIGS. 1 through 3 of the drawings, like numerals being used for like and corresponding parts of the various drawings.

In an embodiment, a system for electronic refund redemption includes a user device (e.g., a wireless communications device running an application) operable to communicate user and/or product identification information to a vendor reader device. The user identification information may include an electronic identification authorized by a refund authority (e.g., a government, retailer, or manufacturer). In certain embodiments, the vendor reader device communicates the user and/or product identification information to a vendor module operable to populate an electronic refund redemption form with the received user and/or product identification information.

The user device and/or vendor module may be operable to communicate user and/or product identification information to an enterprise module operable to determine whether a particular product qualifies for a refund. In an embodiment, the enterprise module receives refund qualification criteria and/or refund redemption criteria from a refund authority operable to grant product refunds and/or set refund qualification criteria and/or refund redemption criteria. The enterprise module may apply the received product and/or user identification information to determine whether the product and/or user is qualified for a refund. In certain embodiments, the enterprise module identifies one or more of the refund qualification criteria, refund redemption criteria, and or refund amounts to users and/or vendors.

FIG. 1 illustrates a block diagram of an example embodiment of a system 100 for electronic refund redemption. System 100 may include one or more of enterprise 102, users 104, vendors 106, customs 108, refund authority 110, and network 112. In certain embodiments, enterprise 102 includes enterprise module 120, user 104 includes user device 130, vendor 106 includes vendor reader devices 140 and vendor module 150, customs 108 includes customs reader device 160 and customs module 170, and refund authority 110 includes refund authority module 180.

Enterprise 102 represents an entity that maintains and operates enterprise module 120 to support electronic refund redemption. Enterprise 102 may provide users 104 with all or a portion (e.g., of hardware and/or software) of user devices 130, may provide vendors with all or a portion (e.g., of hardware and/or software) of vendor reader devices 140 and vendor module 150, may provide customs 108 with all or a portion (e.g., of hardware and/or software) of customs readers 160 and customs module 170, and may provide refund authority 110 with all or a portion (e.g., of hardware and/or software) of refund authority module 180. In certain embodiments, enterprise 102 has different business units or subdivisions that handle different business activities. Enterprise 102 may include organizations such as manufacturers, retailers, governments, commercial banks, savings and loan associations, credit unions, Internet banks, mutual fund companies, brokerage firms, credit card companies, or other provider of electronic refund redemption services.

Users 104 represent customers that purchase products (e.g., goods and/or services) from vendors 106. Users 104 may operate user devices 130 to determine product purchases that qualify for refunds (e.g., VAT refunds), communicate refund information (e.g., passport number, identification information, purchase account information, or any other suitable refund information) to vendors 106, determine redemption criteria (e.g., steps required to be carried out to redeem a refund), satisfy redemption criteria (e.g., communicate required information to the appropriate entities), determine refund amounts, and/or other tasks associated with electronic refund redemptions. In certain embodiments, enterprise 102 provides all or a portion of user devices 130 for users 104 (e.g., hardware and/or software provided for a wireless communications device of users 104) as a service to enable users 104 to electronically redeem refunds associated with products purchased from vendors 106.

Vendors 106 represent entities that sell products (e.g., goods and/or services) to users 104. Vendors 106 may operate vendor reader devices 140 and/or vendor module 150, and may obtain vendor reader device 140 and/or vendor module 150 from enterprise 102. In certain embodiments, enterprise 102 provides all or a portion (e.g., hardware and/or software) of one or more of vendor reader device 140 and vendor module 150 as a service to enable vendors 106 to facilitate the electronic redemption of refunds associated with products purchased from vendors 106 by customers (e.g., users 104).

Customs 108 represents an entity responsible for verifying that users 104 comply with particular refund redemption criteria before obtaining a refund. For example, in embodiments where the refund is a VAT refund, VAT refund redemption criteria often require that a product must be taken out of the territory in which it was purchased to qualify for a VAT refund. Customs 108 may represent the customs and border protection agency of a territory responsible for verifying products are taken out of the territory in which they were purchased before a VAT refund is issued. In other embodiments, customs 108 represents any entity responsible for physically verifying that products and or users 104 satisfy refund qualification and/or refund redemption criteria before a refund is authorized. Customs 108 may operate customs reader devices 160 and/or customs module 170, and may obtain customs reader devices 160 and/or customs module 170 from enterprise 102. In certain embodiments, enterprise 102 provides all or a portion (e.g., hardware and/or software) of one or more of customs reader devices 160 and customs module 170 as a service to enable customs 108 and/or refund authorities 110 to facilitate the electronic redemption of refunds by users 104. Customs 108 may be associated with, or a subdivision of, refund authority 10. In certain embodiments, customs 108 is an agency or contractor of a government operating as refund authority 110. Customs 108 may be a contractor or business unit of a business entity acting as refund authority 110.

Refund authority 110 represents an entity with authority to authorize the payment of refunds to users 104. Refund authority 110 may determine refund amounts, what products qualify for refunds, what users 104 qualify for refunds, refund redemption criteria, or any other information related to product refunds. In embodiments where the refund is a VAT refund, refund authority 110 represents a government of a territory, such as a country, an association of countries (e.g., European Union), or other governmental entity. Refund authority 110 may represent a private entity, such as a business, that offers product refunds (e.g., manufacturer and/or retailer refunds). Refund authority 110 may be associated with source accounts for the transfer of refunds to users 104, and may be responsible for the payment of refunds to users 104. In certain embodiments, refund authority 110 utilizes other entities to provide one or more functions of refund authority 110, for example, contractors to verify that refund qualification criteria are satisfied and that refund payments are properly issued.

Enterprise module 120 represents a component of system 100 operable to receive identifications of products from users 104 and to determine whether the products and/or users 104 qualify for one or more product refunds. Enterprise module 120 may receive refund qualification criteria and/or refund redemption criteria, for example, from refund authority 180. In certain embodiments, refund redemption criteria is determined by enterprise 102 and entered into enterprise module 120. All or a portion of enterprise module 120 may operate on user devices 130. In certain embodiments, enterprise module 120 maintains refund information for users 104, for example, electronic receipts, completed refund forms, information associated with users 104 (e.g., name, address, country of citizenship, passport number, visa number, and/or financial account numbers), and/or other information associated with product refunds. Enterprise module 120 may identify refund amounts for products determined to qualify for a refund, for example, based on refund qualification and/or refund redemption criteria.

In the context of a VAT refund, enterprise module 120 may receive refund redemption criteria (e.g., from enterprise 102 and/or refund authority 180). In certain embodiments, enterprise module 120 receives identification information of products and or users 104 (e.g., from user devices 130, vendor readers 140, vendor module 150, customs reader 160, and/or customs module 170). Enterprise module 120 may receive identification information related to customer users 104 (e.g., passport number, purchase account number, name, or other identification information). In an embodiment, enterprise module 120 applies the received refund redemption criteria to the identified products and/or the identified users 104 to determine whether the identified products and/or users 104 are VAT refund eligible. Enterprise module 120 may identify a VAT refund amount for qualified products.

Enterprise module 120 may determine one or more redemption criteria that must be satisfied to obtain the VAT refund (e.g., allow customs 108 to verify that the purchased product is leaving the territory in which it was purchased) and may communicate these redemption criteria to one or more of users 104, vendors 106, customs 108, and regulatory authority 110. In certain embodiments, enterprise module 120 communicates messages to users 104 (e.g., by user devices 130) to obtain information from users 104 relevant to determining whether a product and/or users 104 is eligible for a refund (e.g., query users 104 to determine whether users 104 intend to remove the product from the jurisdiction where it was purchased). Enterprise module 120 may communicate with any one or more of user devices 130, vendor readers 140, vendor modules 150, customs readers 160, customs modules 170 and refund authority module 180 to exchange any suitable information relevant to the redemption of product refunds.

User devices 130 represent devices operable to communicate users 104 information (e.g., name, address, country of citizenship, passport number, visa number, and/or financial account numbers) to obtain product refunds (e.g., VAT refunds). User devices 130 may be wireless communications devices (e.g., smart phones or tablets running software such as mobile applications), an electronic ID card (e.g., a license or passport operable to communicate information electronically), or any other suitable device. In certain embodiments, user devices 130 communicate using one or more of near frequency communication (NFC), radio frequency identification (RFID), over a network such as the Internet, through electronic scan (e.g., barcodes or image codes), or any other suitable electronic communication method. User devices 130 may communicate with one or more of enterprise module 120, vendor readers 140, vendor modules 150, customs readers 160, customs modules 170, and refund authority module 180.

In certain embodiments, user device 130 is operable to communicate user 104 information to vendor readers 140 and/or customs readers 160. User device 130 may communicate user 104 information to vendor readers 140 during a transaction for a product, for example, to facilitate the population of user 104 information into a refund form (e.g., VAT refund form) associated with the product purchase. In certain embodiments, user devices 130 are operable to communicate user 104 information to customs readers 160, for example, product refund forms, name, address, country of citizenship, passport number, visa number, and/or financial account numbers, to facilitate the redemption of refunds. User devices 130 may communicate user 104 information in the form of an authorized (e.g., by a territorial government and/or refund authority 110) digital identifier (e.g., an authorized electronic passport or identifier card), and may include user 104 authentication information, digital images of users 104, user 104 passport information, or any other suitable user 104 identification information.

User devices 130 may receive communications from components of system 100 (e.g., enterprise module 120, vendor module 150, customs module 170, and/or refund authority module 180) requesting information related to refund eligibility criteria. For example, user devices 130 may receive messages inquiring whether users 104 intend to remove a purchased product from the territory in which it was purchased (e.g., leave the purchase country with the product to qualify for a VAT refund).

In certain embodiments, user devices 130 are operable to communicate product identification information (e.g., barcode information) to enterprise module 120, for example, to determine whether an identified product is eligible for a refund. User devices 130 may receive information relating to whether identified products are eligible for particular refunds (e.g., VAT refunds), and may receive information related to refund redemption criteria, for example, from enterprise module 120, vendor module 150, customs module 170, or refund authority 180. In certain embodiments, user device 130 is a module. User device 130 may operate some or all of enterprise module 120. In an embodiment, user device 130 may identify refund amounts for products determined to qualify for a refund, for example, based on communication with enterprise module 120.

Vendor reader devices 140 represent devices operable to communicate with user devices 130 to receive user 104 information (e.g., name, address, country of citizenship, passport number, visa number, and/or financial account numbers) for vendors 106. Vendor reader devices 140 may be operable to identify products purchased by users 104. In certain embodiments, vendor reader devices 140 communicate received user 104 identification information and/or product identification information to vendor module 150 and/or enterprise module 120. Vendor reader devices 140 may be modules.

Vendor module 150 represents a component of system 100 operable to receive user 104 and/or product identification information and populate refund forms with the received info nation (e.g., from vendor reader devices 140 and/or user devices 130). Vendor module 150 may receive refund qualification criteria and/or refund redemption criteria from enterprise module 120 or refund authority 180. In certain embodiments, vendor module 150 receives user 104 and/or product identification information and populate refund forms with the received information. In an embodiment, vendor module 150 communicates one or more of a populated electronic refund form and/or receipt to user 104 (e.g., user device 130). Vendor module 150 may print a physical refund form and/or receipt. In certain embodiments, vendor module 150 is operable to identify products that qualify for refund (e.g., by communicating with enterprise module 120 and/or performing functions of enterprise module 120) and populate a refund form with an identification of the qualifying products. Vendor module 150 may identify refund amounts for products determined to qualify for a refund, for example, based on communication with enterprise module 120 and/or user devices 130.

Customs reader device 160 represents a device operable to communicate with user devices 130 to receive user 104 information (e.g., name, address, country of citizenship, passport number, visa number, and/or financial account numbers) for customs 108. Customs reader device 160 may be operable to identify products purchased by users 104. In certain embodiments, customs reader device 140 communicates received user 104 identification information and/or product identification information to customs module 170, regulatory authority 180, and/or enterprise module 120. Vendor reader device 140 may be a module.

Customs module 170 represents a component of system 100 operable to receive one or more of refund qualification criteria, refund redemption criteria, user 104 identification information, and product identification information and to verify that the received user 104 identification information and/or product identification information comply with the received refund qualification criteria and/or refund redemption criteria. Customs module 170 may receive refund qualification criteria and/or refund redemption criteria from refund authority 180. In certain embodiments, customs module 170 receives user 104 and/or product identification information from one or more of user device 130 and customs reader device 160. In the context of a VAT refund, a user 104 may communicate user 104 identification information (e.g., electronic passport), product identification information, purchase receipts, refund forms, or other necessary information to customs reader 160 using user device 130. In an embodiment, customs reader 160 communicates the received information to customs module 170 so that customs module 170 can verify that the received user 104 identification information and/or product identification information comply with the refund qualification criteria and/or refund redemption criteria. Customs module 170 may identify refund amounts for products determined to qualify for a refund, for example, based on communication with enterprise module 120, refund authority module 180, and/or user devices 130. Customs module 170 may communicate with refund authority module 180 and/or enterprise module 120 to provide notification that refund qualification criteria and/or refund redemption criteria have been satisfied. In certain embodiments, customs module 170 is operable to pay refunds to users 104, and/or to authorize agents of refund authority 180 to pay refunds to users (e.g., enterprise 102).

Refund authority module 180 represents a component of system 100 operable to authorize product refunds. Refund authority module 180 may communicate refund qualification criteria and/or refund redemption criteria to enterprise module 120, user devices 130, vendor module 140, and/or customs module 170. In certain embodiments, refund authority module 180 authorizes payment of refunds once verification of refund qualification criteria and/or refund redemption criteria are satisfied. For example, in the context of VAT refunds, refund authority module 180 may authorize payment when customs module 170 notifies refund authority module 180 that the refund qualification criteria and/or refund redemption criteria are satisfied. Refund authority module 180 may identify refund amounts for products determined to qualify for a refund, for example, based on communication with enterprise module 120 and/or user devices 130. In certain embodiments, refund authority 110 may delegate refund authorization to an agent, for example, customs 108 or a contractor.

Network 190 represents any suitable network operable to facilitate communication between components of system 100, such as enterprise 102, users 104, vendors 106, customs 108, refund authorities 110, enterprise modules 120, user device 130, vendor reader devices 140, vendor modules 150, customs reader devices 160, customs modules 170, and refund authority modules 180. Network 190 may include any interconnecting system capable of transmitting audio, video, electrical signals, optical signals, data, messages, or any combination of the preceding. Network 190 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

A module (e.g., modules 120, 130, 140, 150, 160, 170, and 180) may execute any suitable operating system such as IBM's zSeries/Operating System (z/OS), MS-DOS, PC-DOS, MAC-OS, WINDOWS, a .NET environment, UNIX, OpenVMS, Android, Apple iOS, Linux, Windows Phone, or any other appropriate operating system, including mobile and future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as enterprise modules 120, user device 130, vendor reader devices 140, vendor modules 150, customs reader devices 160, customs modules 170, and refund authority modules 180, may include one or more processors, interfaces, memories, and/or databases. A processor represents any computing device, such as processors 122, 132, 142, 152, 162, 172, and 182, configured to control the operation of one or more components of system 100. A processor may comprise one or more processors and may be a programmable logic device, a microcontroller, a microprocessor, any suitable processing device, or any suitable combination of the preceding. A processor includes any hardware or software that operates to control and process information received by a component of system 100. In certain embodiments, a processor communicatively couples to other components of system 100, such as a module (e.g., modules 120, 130, 140, 150, 160, 170, and 180), an interface (e.g., an interface 124, 134, 144, 154, 164, 174, and 184), a memory (e.g., memories 126, 136, 146, 156, 166, 176, and 186), a database (e.g., databases 128, 138, 148, 158, 168, 178, and 188), or any other suitable component.

An interface represents any device, such as interfaces 124, 134, 144, 154, 164, 174, and 184, operable to receive input, send output, process the input or output, or perform other suitable operations for a component of system 100. An interface includes any port or connection, real or virtual, including any suitable hardware or software, including protocol conversion and data processing capabilities, to communicate through network 190. In certain embodiments, an interface includes a user interface (e.g., physical input, graphical user interface, touchscreen, buttons, switches, transducer, or any other suitable method to receive input from a user).

A memory represents any device, such as memories 126, 136, 146, 156, 166, 176, and 186 operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of a component of system 100. A memory may further include some or all of one or more databases (e.g., databases 128, 138, 148, 158, 168, 178, and 188).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

In an embodiment of operation, users 104 purchasing products may identify products associated with refunds (e.g., VAT refunds), communicate user 104 identification information (e.g., name, address, country of citizenship, passport number, visa number, and/or financial account numbers) to vendors 106 selling the products, receive notification of products qualifying for a refund, receive refund qualification criteria (e.g., criteria describing products eligible for a refund), receive refund redemption criteria (e.g., criteria describing procedures for redeeming a refund), receive identification of refund amounts, store electronic information (e.g., forms, identification information, receipts, lists of purchased products associated with refunds, etc.) associated with product refunds, and/or receive refund payment.

For example, user 104 may identify a product of vendor 106 that user 104 is interested in purchasing and, using user device 130 (e.g., a wireless communication device running an application), identify the product (e.g., by scanning a barcode, picture code, taking a picture, describing the make and model in an application, etc.). In an embodiment, once the product is identified, user device 130 can communicate with enterprise module 120 to determine whether the identified product is associated with a refund. User 104 may communicate product and/or user 104 identification information to the enterprise module 120. In certain embodiments, user 104 information represents an electronic identification authorized for use in obtaining refunds by refund authority 180 (e.g., a manufacturer, retailer, government, etc.). For example, in the context of a VAT refund, user 104 information may be an electronic passport authorized for use in obtaining VAT refunds by the jurisdiction where the purchase was made.

Enterprise module 120 may collect refund qualification criteria and refund redemption criteria from refund authorities (e.g., entities with authority to issue refunds for products) or other sources (e.g., publically available information), apply the refund qualification criteria and/or refund redemption criteria to identified product and/or user 104 information to determine whether the identified product and/or identified user 104 qualify for a refund, or identify refund amounts for products. In certain embodiments, enterprise module 120 requests additional information from user 104, for example, whether user 104 intends to comply with certain refund qualification criteria and/or refund redemption criteria (e.g., exiting the jurisdiction of purchase with the product to collect a VAT refund). Enterprise module 120 may communicate to user device 130 a message indicating whether the identified product qualifies for a refund and may identify an amount of the refund.

In certain embodiments, vendors 106 maintain vendor reader devices 140 operable to communicate with user devices 130 to communicate information associated with refunds between vendors 106 and users 104. For example, vendor 106 may identify a product being purchased by user 104 (e.g., by barcode, picture code, identification of make and/or model of the product) and communicate the product identification to one or more of vendor module 150, user device 130, and enterprise module 120. In an embodiment, user device 130 is operable to communicate with vendor reader device 140 to communicate user 104 identification information to vendor 106. Vendor module 150 may receive product identification and user 104 identification information (e.g., from vendor reader devices 140 and/or user devices 130) and populate an electronic refund form with the product identification and/or user 104 identification information. In certain embodiments, vendor module 150 communicates with enterprise module 120 to determine whether the identified product and/or user qualify for a refund. Vendor module 150 may communicate the populated electronic refund form to user device 130 and/or enterprise module 120 and user 104 may access the populated refund form through user device 130. In certain embodiments, vendor module 150 communicates an electronic receipt of the purchase to user device 130 and/or the enterprise module 120 and user 104 may access the electronic receipt through user device 130. Vendor 106 may also print a physical copy of the receipt and/or populated refund form.

In certain embodiments, refund qualification criteria and/or refund redemption criteria are physically verified by refund authority 180 or an agent of the refund authority (e.g., customs 108). In the context of VAT refunds, customs 108 of the jurisdiction where the product was purchased may physically verify that user 104 is leaving the jurisdiction (e.g., country) and is taking the purchased product out of the jurisdiction. In particular embodiments, customs 108 need one or more of the receipt of purchase, a completed refund form associated with the purchase, a passport, and may need to physically verify the product is leaving the jurisdiction before authorizing a refund. Customs 108 may maintain customs reader device 160 and/or customs modules 170. In an embodiment, user devices 130 are able to communicate product identification information, user identification information, receipts, refund forms, or other suitable information electronically (e.g., by radio, near frequency communication (“NFC”), radio frequency identification (“RFID”), etc.) to customs reader 160. Customs reader 160 may communicate the received information to customs module 170, and customs module 170 may authorize the product refund and/or communicate with refund authority 180 to issue a refund. Once a refund is authorized, user 104 may receive the refund payment, for example, to an account associated with the purchase, an account associated with user 104, in cash, or any other suitable form of payment.

Modifications, additions, or omissions may be made to system 100. System 100 may include more, fewer, or other components. Any suitable component of system 100 may include a processor, interface, logic, memory, database, or other suitable element.

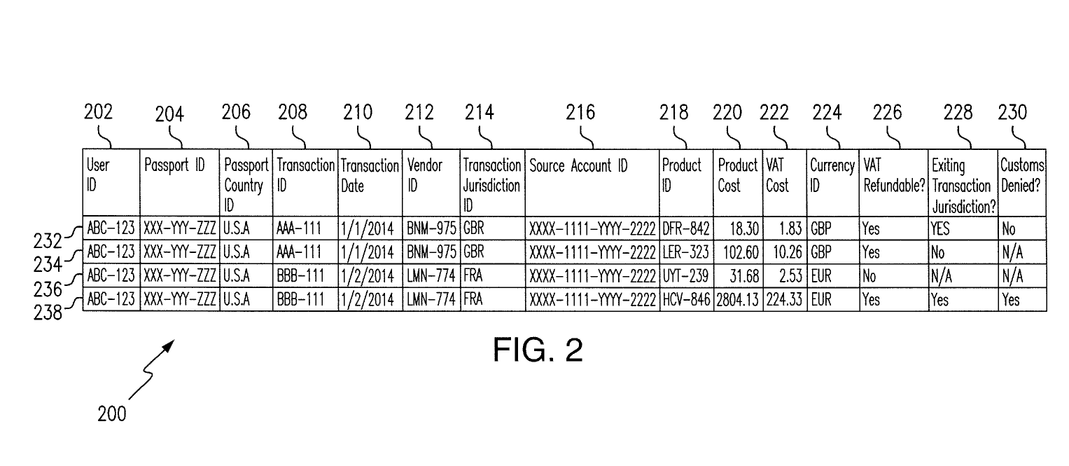

FIG. 2 illustrates a table 200 of database fields that may be used in an example embodiment of electronic refund redemption. In the illustrated embodiment, table 200 includes user ID field 202, passport ID field 204, passport country ID field 206, transaction ID field 208, transaction date field 210, vendor ID field 212, transaction jurisdiction ID 214, source account ID field 216, product ID field 218, product cost field 220, VAT cost field 222, currency ID field 224, VAT refundable field 226, exiting transaction location field 228, customs denied field 230, and example field values in rows 232, 234, 236, and 238.

User ID field 202 represents an identification code associated with particular users 104. User ID field 202 may be a name, number, or any other suitable indicia operable to identify particular users 104, and may be assigned by enterprise 102, users 104, vendors 106, customs 108, or refund authority 110. In certain embodiments, user ID field 202 includes uniquely identifiable identification codes for users 104 such that each ID code is assigned to only one user 104.

Passport ID field 204 represents an identification code associated with the passport of users 104 (e.g., the passport number assigned to the passport). Passport ID field 204 may be a name, number, or any other suitable indicia operable to identify particular users 104, and may be assigned by enterprise 102, users 104, vendors 106, customs 108, or refund authority 110. In certain embodiments, passport ID field 204 includes uniquely identifiable identification codes associated with the passport of users 104 such that each ID code is assigned to only one user 104 passport.

Passport country ID field 206 represents an identification code of the country associated with the passport of users 104. Passport country ID field 206 may be a name, number, or any other suitable indicia operable to identify the country associated with the passport of users 104. In certain embodiments, passport country ID field 206 includes uniquely identifiable identification codes for countries such that passport country ID code is assigned to only one country.

Transaction ID field 208 represents an identification code associated with product purchase transactions between users 104 and vendors 106. Transaction ID field 208 may be a name, number, or any other suitable indicia operable to identify particular transactions between users 104 and vendors 106, and may be assigned by enterprise 102, users 104, vendors 106, customs 108, or refund authority 110. In certain embodiments, transaction ID field 208 includes uniquely identifiable identification codes for transactions such that each transaction ID code is assigned to only one transaction or one transaction per user 104. Transaction date field 210 represents a date associated with the product purchase transaction between the user 104 and the vendor 106 (e.g., the date the transaction occurred).

Vendor ID field 212 represents an identification code associated with particular vendors 106. Vendor ID field 212 may be a name, number, or any other suitable indicia operable to identify particular users 104, and may be assigned by enterprise 102, users 104, vendors 106, customs 108, or refund authority 110. In certain embodiments, vendor ID field 212 includes uniquely identifiable identification codes for vendors 106 such that each vendor ID code is assigned to only one vendor 106.

Transaction jurisdiction ID 214 represents an identification code associated with particular jurisdictions (e.g., countries or territories) in which product purchase transactions between users 104 and vendors 106 occur. Transaction jurisdiction ID field 214 may be a name, number, or any other suitable indicia operable to identify particular users 104, and may be assigned by enterprise 102, users 104, vendors 106, customs 108, or refund authority 110. In certain embodiments, transaction jurisdiction ID field 214 includes uniquely identifiable identification codes for jurisdictions such that each transaction jurisdiction ID code is assigned to only one jurisdiction. A transaction jurisdiction may be associated with multiple transaction jurisdiction ID codes. For example, a country within the European Union may be associated with a jurisdiction ID code for the country and the jurisdiction ID code of the European Union.

Source account ID field 216 represents an identification code associated with a financial account of users 104. Source account ID field 216 may be a name, number, or any other suitable indicia operable to identify a financial account of users 104, and may be assigned by enterprise 102, users 104, vendors 106, customs 108, or refund authority 110. In certain embodiments, source account ID field 216 includes uniquely identifiable identification codes for users 104 such that each source account ID code is assigned to only one account. Source accounts may be a particular financial account associated with users 104, and may be the source account for the purchase of the product (e.g., a credit card account used in the product purchase).

Product ID field 218 represents an identification code associated with particular products, or particular categories of products. Product ID field 218 may be a name, number, or any other suitable indicia operable to identify particular products and/or product categories, and may be assigned by enterprise 102, users 104, vendors 106, customs 108, or refund authority 110. In certain embodiments, product ID field 218 includes uniquely identifiable identification codes for products and/or product categories such that each product ID code is assigned to only one product or product category.

Product cost field 220 represents the price paid for the product purchased by user 104 from vendor 106. Product cost field 220 may include only the cost of the product and exclude other costs (e.g., VAT). In certain embodiments, product cost field 220 includes the total cost paid for the product including other costs (e.g., VAT). VAT cost field 222 represents the VAT paid for the product purchased by user 104 from vendor 106. VAT cost field 222 may only include the VAT paid by users 104 for products purchased from vendors 106.

Currency ID field 224 represents an identification code associated with the currency used in the transaction between the user 104 and the vendor 106. Currency ID field 224 may be a name, number, or any other suitable indicia operable to identify currencies, and may be assigned by enterprise 102, users 104, vendors 106, customs 108, or refund authority 110. In certain embodiments, currency ID field 224 includes uniquely identifiable identification codes for currencies such that each currency ID code is assigned to only one currency.

VAT refundable field 226 represents an indication of whether the product identified in product ID field 218 qualifies for a VAT refund. VAT refundable field 226 may be populated after application of refund redemption criteria to information received regarding the product identified in product ID field 218 and/or the user 104 identified in user ID field 202. In certain embodiments, VAT refundable field 226 is populated after determining whether all refund redemption criteria have been satisfied.

Exiting transaction location field 228 represents an indication of whether the user 104 identified in user ID field 202 has indicated that the user 104 intends to remove the product identified in product ID field 218 from the jurisdiction identified in transaction jurisdiction ID field 214. The indication may be received from user device 130 associated with user 104 identified in user ID field 202. VAT refund redemption criteria often require that a purchased product must be removed from the transaction jurisdiction to qualify for a VAT refund.

Customs denied field 230 represents an indication of whether VAT refund was denied by customs 108 (e.g., because user 104 was not in possession of the product identified in product ID field 218 when user 104 exited the transaction jurisdiction identified in transaction jurisdiction field 214). Customs denied field 230 may be populated by customs module 170, or in response to notification from customs module 170 (e.g., to user device 130 and/or enterprise module 120) that the product identified by product ID field 218 is not authorized for a refund.

Rows 232, 234, 236, and 238 illustrate example values for the above referenced fields and describe two transactions by user 104 at two vendors 160 in two jurisdictions. The values for user ID field 202, passport ID field 204, and passport country ID field 206 for row 232 are “ABC-123,” “XXX-YYY-ZZZ,” and “U.S.A.” respectively, and do not change in rows 234, 236, and 238 because all transactions described in FIG. 2 involve the same user 104.

Rows 232 and 234 describe a transaction (transaction ID field 208 value of “AAA-111”) on Jan. 1, 2014 (transaction date field 210 value of “1/1/2014”), at a vendor (vendor ID field 212 value of “BNM-975”) in Great Britain (transaction jurisdiction ID field 214 value of “GBR”). Row 232 describes a product (product ID field 218 value “DFR-842”) that cost £18.30 (product cost field 220 value of “18.30” and currency ID field 224 value “GBP”) and had a VAT cost of £1.83 (VAT cost field 222 value of “1.83” and currency ID field 224 value of “GBP”) and was paid using account XXXX-1111-YYYY-2222 (source account ID field 216 value “XXXX-1111-YYYY-2222”). Product DFR-842 was determined to be qualified for a VAT refund (VAT refundable field 226 value “Yes”), user 104 indicated that user 104 intends to exit the jurisdiction of purchase (e.g., Great Britain) (exiting transaction jurisdiction field 228 value “Yes”), and customs 108 did not deny the refund (customs denied field 230 value “No”). Product DFR-824 is VAT refund eligible.

Row 234 describes a product (product ID field 218 value “LER-323”) that cost £102.60 (product cost field 220 value of “102.60” and currency ID field 224 value “GBP”) and had a VAT cost of £10.26 (VAT cost field 222 value of “10.26” and currency ID field 224 value of “GBP”) and was paid using account XXXX-1111-YYYY-2222 (source account ID field 216 value “XXXX-1111-YYYY-2222”). Product LER-323 was determined to be qualified for a VAT refund (VAT refundable field 226 value “Yes”), however, user 104 indicated that the product will not exit the jurisdiction of purchase (e.g., Great Britain) (exiting transaction jurisdiction field 228 value “No”), and accordingly, product LER-323 is not eligible for a VAT refund and the product is not taken to customs 108 (customs denied field 230 value “N/A”).

Rows 234 and 236 describe a transaction (transaction ID field 208 value of “BBB-222”) on Jan. 2, 2014 (transaction date field 210 value of “1/2/2014”), at a vendor (vendor ID field 212 value of “LMN-774”) in France (transaction jurisdiction ID field 214 value of “FRA”). Row 236 describes a product (product ID field 218 value “UYT-239”) that cost [symbol] 31.68 (product cost field 220 value of “31.68” and currency ID field 224 value “EUR”) and had a VAT cost of [symbol] 2.53 (VAT cost field 222 value of “2.53” and currency ID field 224 value of “EUR”) and was paid using account XXXX-1111-YYYY-2222 (source account ID field 216 value “XXXX-1111-YYYY-2222”). Product UYT-239 was determined not to be qualified for a VAT refund (VAT refundable field 226 value “No”), and accordingly no VAT refund is issued and the exiting transaction jurisdiction field 228 value and customs denied field 230 value are “N/A.”

Row 238 describes a product (product ID field 218 value “HCV-846”) that cost [symbol] 2804.13 (product cost field 220 value of “2804.13” and currency ID field 224 value “EUR”) and had a VAT cost of [symbol] 224.33 (VAT cost field 222 value of “224.33” and currency ID field 224 value of “EUR”) and was paid using account XXXX-1111-YYYY-2222 (source account ID field 216 value “XXXX-1111-YYYY-2222”). Product HCV-846 was determined to be qualified for a VAT refund (VAT refundable field 226 value “Yes”), user 104 indicated that the product will exit the jurisdiction of purchase (e.g., France) (exiting transaction jurisdiction field 228 value “Yes”), however, customs 108 denied the refund (customs denied field 230 value “No”), for example, because user 104 did not bring product HCV-846 to customs 108. Accordingly, no VAT refund is issued.

Modifications, additions, or omissions may be made to table 200. Table 200 may include more or less fields, and may include any suitable information. Table 200 may include any suitable amount of information and may be stored in any suitable type or number of memories.

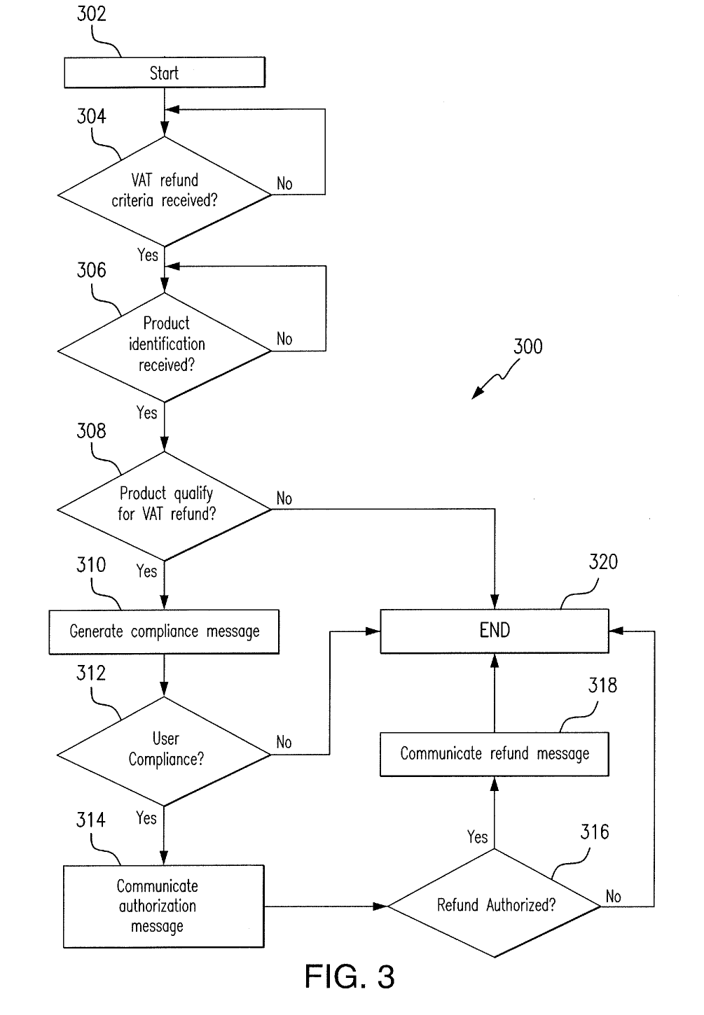

FIG. 3 illustrates an example embodiment of a method 300 for electronic refund redemption. Method 300 starts at step 302. At step 304, it is determined whether VAT refund criteria has been received (e.g., by enterprise module 120). If it is determined that no VAT refund criteria has been received, the method moves to step 304. If VAT refund criteria has been received, the method moves step 306. At step 306, it is determined whether product identification information has been received (e.g., by enterprise module 120). If it is determined that product identification information has not been received, the method moves to step 306. If it is determined that product information has been received, the method moves to step 308.

At step 308, it is determined (e.g., by enterprise module 120) whether the identified product qualifies for a VAT refund under the received VAT refund criteria. If it is determined that the identified product does not qualify for a VAT refund under the received VAT refund criteria, the method moves to step 320 and the method ends. If it is determined that the identified product does qualify for a VAT refund under the received VAT refund criteria, the method moves to step 310. At step 310, a message is communicated (e.g., by enterprise module 120) to user device 130 associated with the identified product (e.g., the user device 130 that communicated the product identification to enterprise module 120) identifying VAT refund redemption criteria and requesting an indication of whether a user 104 associated with the user device 130 intends to comply with VAT refund redemption criteria (e.g., intends to leave the territory with the identified product). At step 312 it is determined (e.g., by enterprise module 120), whether user 104 intends to comply with the identified VAT refund redemption criteria. If user 104 indicates that user 104 does not intend to comply with the identified VAT refund redemption criteria, the method moves to step 320 and ends. If user 104 indicates that user 104 does intend to comply with the identified VAT refund redemption criteria, the method moves to step 314.

At step 314, an authorization message requesting authorization to redeem a VAT refund for the identified product is communicated (e.g., from enterprise module 120 to customs reader 160, customs module 170, refund authority module 180, or any other entity with authority to authorize VAT refunds). At step 316, it is determined (e.g., by enterprise module 120) whether a VAT refund for the identified product is authorized (e.g., by customs module 170 or refund authority 180). If it is determined that a VAT refund for the identified product is not authorized, the method moves to step 320 and ends. If it is determined that a VAT refund for the identified product is authorized, the method moves to step 318. At step 318, a refund message is communicated to an entity (e.g., customs module 170 or refund authority module 180) operable to pay the refund (e.g., by transferring the refund amount to the account associated with the purchase of the product) that includes the authorization (e.g., authentication codes) for the VAT refund. The method ends at step 320.

Modifications, additions, or omissions may be made to method 300. The method may include more, fewer, or other steps. Additionally, steps may be performed in any suitable order, in parallel, and/or sequentially. Any suitable component of may perform one or more steps of method 300.

Certain embodiments of the present disclosure may provide one or more technical advantages having specific technical effects. In certain embodiments, a system for electronic refund redemption identifies products that qualify for refunds, thereby conserving the bandwidth, computational resources, and memory consumed by customers searching for information to determine whether their purchased products qualify for a refund.

In an embodiment, a system for electronic refund redemption identifies refund redemption criteria for a particular product refund, thereby conserving the bandwidth, computational resources, and memory consumed by customers searching for information to determine refund redemption criteria for particular purchased products.

In particular embodiments, a system for electronic refund redemption includes an electronic passport, thereby preventing theft or loss of customer passports and conserving the bandwidth, computational resources, and memory consumed by obtaining replacement passports.

In certain embodiments, a system for electronic refund redemption facilitates electronic transfer of customer data to product refund forms, thereby conserving the bandwidth, computational resources, and memory consumed by manually entering customer information into an electronic product refund form.

Other technical advantages of the present disclosure will be readily apparent to one skilled in the art from the following figures, descriptions, and claims. Moreover, while specific advantages have been enumerated above, various embodiments may include all, some, or none of the enumerated advantages.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A system for electronic refund redemption, comprising:
an interface operable to:
receive an electronic communication identifying a product purchased by a user from a vendor and an amount of value added tax (VAT) included for the purchased product;
receive an identification of a VAT jurisdiction in which the product was purchased;
receive VAT refund criteria associated with the VAT jurisdiction in which the product was purchased, wherein the VAT refund criteria identifies products subject to a VAT refund in the VAT jurisdiction; and
communicate, electronically, a passport number associated with the user to a device associated with the vendor;
a processor, communicatively coupled to the interface, operable to:
determine, based on the received VAT refund criteria, that the purchased product qualifies for a VAT refund and a VAT refund amount for the purchased product; and
generate, based on the determination that the purchased product qualifies for the VAT refund, a compliance message to a user identifying at least a portion of the VAT refund criteria and requesting an indication of whether the user intends to comply with the identified VAT refund criteria;
the interface further operable to:
communicate the compliance message to the user; and
receive an indication that the user intends to comply with the identified VAT refund criteria;
the processor further operable to generate an authorization message that includes the VAT refund amount for the purchased product; and
the interface further operable to:
communicate the authorization message to an entity authorized to approve the VAT refund for the purchased product; and
receive an authorization message from the entity authorizing the VAT refund for the purchased product.

2. A system for electronic refund redemption, comprising:
an interface operable to:
receive an electronic communication identifying a product purchased by a user from a vendor and an amount of value added tax (VAT) included for the purchased product; and
receive VAT refund criteria associated with the VAT jurisdiction in which the product was purchased, wherein the VAT refund criteria identifies products subject to a VAT refund in the VAT jurisdiction; and
a processor, communicatively coupled to the interface, operable to determine, based on the received VAT refund criteria, that the purchased product qualifies for a VAT refund and a VAT refund amount for the purchased product.

3. The system of claim 2, the interface further operable to communicate, electronically, a passport number associated with the user to a device associated with the vendor.

4. The system of claim 3, wherein the electronically communicated passport number represents a digital passport authorized by a VAT jurisdiction for use in redeeming VAT refunds.

5. The system of claim 2, the processor further operable to generate, based on the determination that the purchased product qualifies for the VAT refund, a compliance message to a user identifying at least a portion of the VAT refund criteria and requesting an indication of whether the user intends to comply with the identified VAT refund criteria; and
the interface further operable to:
communicate the compliance message to the user; and
receive an indication that the user intends to comply with the identified VAT refund criteria.

6. The system of claim 2, the processor further operable to:
generate a refund message that includes the VAT refund amount for the purchased product; and
the interface further operable to:
communicate the refund message to an entity authorized to approve the VAT refund for the purchased product; and
receive an authorization message from the entity authorizing the VAT refund for the purchased product.

7. The system of claim 2, the interface further operable to receive an identification of a VAT jurisdiction in which the product was purchased.

8. The system of claim 2, the processor further operable to:
generate an electronic VAT refund form for a VAT jurisdiction in which the product was purchased that includes the determined VAT refund amount for the purchased product; and
the interface further operable to communicate the electronic VAT refund form to a device associated with a customs representative of the VAT jurisdiction in which the product was purchased.

9. A non-transitory computer readable storage medium comprising logic for electronic refund redemption, the logic operable, when executed by a processor, to:
receive an electronic communication identifying a product purchased by a user from a vendor and an amount of value added tax (VAT) included for the purchased product;
receive VAT refund criteria associated with the VAT jurisdiction in which the product was purchased, wherein the VAT refund criteria identifies products subject to a VAT refund in the VAT jurisdiction; and
determine, based on the received VAT refund criteria, that the purchased product qualifies for a VAT refund and a VAT refund amount for the purchased product.

10. The non-transitory computer readable storage medium of claim 9, the logic further operable to communicate, electronically, a passport number associated with the user to a device associated with the vendor.

11. The non-transitory computer readable storage medium of claim 10, wherein the electronically communicated passport number represents a digital passport authorized by a VAT jurisdiction for use in redeeming VAT refunds.

12. The non-transitory computer readable storage medium of claim 9, the logic further operable to:
generate, based on the determination that the purchased product qualifies for the VAT refund, a compliance message to a user identifying at least a portion of the VAT refund criteria and requesting an indication of whether the user intends to comply with the identified VAT refund criteria;
communicate the compliance message to the user; and
receive an indication that the user intends to comply with the identified VAT refund criteria.

13. The non-transitory computer readable storage medium of claim 9, the logic further operable to:
generate a refund message that includes the VAT refund amount for the purchased product;
communicate the refund message to an entity authorized to approve the VAT refund for the purchased product; and
receive an authorization message from the entity authorizing the VAT refund for the purchased product.

14. The non-transitory computer readable storage medium of claim 9, the logic further operable to receive an identification of a VAT jurisdiction in which the product was purchased.

15. The non-transitory computer readable storage medium of claim 9, the logic further operable to:
generate an electronic VAT refund form for a VAT jurisdiction in which the product was purchased that includes the determined VAT refund amount for the purchased product; and
communicate the electronic VAT refund form to a device associated with a customs representative of the VAT jurisdiction in which the product was purchased.

16. A method for electronic refund redemption, comprising:
receiving an electronic communication identifying a product purchased by a user from a vendor and an amount of value added tax (VAT) included for the purchased product;
receiving VAT refund criteria associated with the VAT jurisdiction in which the product was purchased, wherein the VAT refund criteria identifies products subject to a VAT refund in the VAT jurisdiction; and
determining, by a processor, based on the received VAT refund criteria, that the purchased product qualifies for a VAT refund and a VAT refund amount for the purchased product.

17. The method of claim 16, further comprising communicating, electronically, a passport number associated with the user to a device associated with the vendor.

18. The method of claim 16, further comprising:
generating, based on the determination that the purchased product qualifies for the VAT refund, a compliance message to a user identifying at least a portion of the VAT refund criteria and requesting an indication of whether the user intends to comply with the identified VAT refund criteria;
communicating the compliance message to the user; and
receiving an indication that the user intends to comply with the identified VAT refund criteria.

19. The method of claim 16, further comprising:
generating a refund message that includes the VAT refund amount for the purchased product;
communicating the refund message to an entity authorized to approve the VAT refund for the purchased product; and
receiving an authorization message from the entity authorizing the VAT refund for the purchased product.

20. The method of claim 16, further comprising:
generating an electronic VAT refund form for a VAT jurisdiction in which the product was purchased that includes the determined VAT refund amount for the purchased product; and
communicating the electronic VAT refund form to a device associated with a customs representative of the VAT jurisdiction in which the product was purchased.
